(19) United States
(12) Patent Application Publication
(10) Pub. No.: US 2024/0157484 A1
(43) Pub. Date: May 16, 2024

(54) FULL SLAG COVERING, SPATTER-FREE FLUX-CORED WELDING WIRE

(71) Applicants: HARBIN INSTITUTE OF TECHNOLOGY, WEIHAI, Weihai (CN); HARBIN INSTITUTE OF TECHNOLOGY -WEIHAI INNOVATION PARK, WEIHAI, Weihai (CN)

(72) Inventors: Ning Guo, Weihai (CN); Xin Zhang, Weihai (CN); Changsheng Xu, Weihai (CN); Yanbo Tan, Weihai (CN); Wenxue Luo, Weihai (CN); Yunlong Fu, Weihai (CN)

(21) Appl. No.: 18/416,936

(22) Filed: Jan. 19, 2024

Related U.S. Application Data
(63) Continuation of application No. PCT/CN2021/117887, filed on Sep. 13, 2021.

(30) Foreign Application Priority Data
Jul. 20, 2021 (CN) 202110817104.1

(51) Int. Cl. B23K 35/02; B23K 35/36; B23K 35/368

(52) U.S. Cl. CPC B23K 35/0266; B23K 35/3605; B23K 35/368

(57) ABSTRACT

A full slag covering, spatter-free flux-cored welding wire, relating to the technical field of welding material formulations, which includes a flux core and a metal sheath, wherein the flux core is a slag system based on a neutral slag of calcium oxide-titanium dioxide-aluminum oxide; and molten drops are prevented from flying out to form spatters under the action of liquid slag in a welding process. The flux core is composed of rutile, fluoride, titanate, aluminum powder, manganese powder, chromium powder, molybdenum powder and iron powder, and mass percentages of respective components are: 15%-35% rutile, 15%-35% fluoride, 3%-7% calcium titanate, 5%-10% aluminum powder, 10%-20% manganese powder, 3%-5% chromium powder, 3%-15% molybdenum powder, and a remainder is iron powder or nickel powder. The present welding wire solves the technical problems of weld spatter and poor stability in the traditional welding process.

### CROSS-REFERENCE TO RELATED APPLICATIONS

The present application is a Continuation Application of PCT Application No. PCT/CN2021/117887, filed on Sep. 13, 2021, which claims the priority of Chinese patent application No. 202110817104.1, filed on Jul. 20, 2021, the entire contents of which are hereby incorporated by reference.

### TECHNICAL FIELD

The present disclosure relates to the technical field of welding material formulations, and in particular to a full slag covering, spatter-free flux-cored welding wire.

### DESCRIPTION OF THE PRIOR ART

Flux-cored welding wire, also known as powder-cored welding wire or tubular welding wire, is a wire-shaped welding material with a tubular cross-section composed of internal powder and an external metal coat. The flux-cored welding wire has characteristics of continuous production and use, and the composition of its internal powder can be designed and adjusted according to different usage conditions and desired effects. As a result, it has been widely used in high-temperature-resistant materials, wear-resistant materials, high-strength materials, antifriction materials and even some extreme environments such as underwater.

At present, the stability control of the welding process and the suppression of various types of welding spatters have always been urgent problems to be solved in the flux-cored wire welding. One of the reasons for the unstable welding process and increased welding spatters is the gasification of components such as slag-forming agents and gas-generating agents of the flux-cored wires under the thermal action of the welding arc. This often leads to frequent short circuits or arc breaks, significantly reducing the continuity of the weld seam. Additionally, excessive spatters often accumulate on both sides and the surface of the weld seam, making it difficult to remove and greatly reducing the size morphology and surface smoothness of the weldment. In more complex environments, such as underwater, environmental factors have a greater interference effect on the welding process, resulting in to poorer stability of the welding process and a larger number of weld spatters. Therefore, there is an urgent need for a welding wire design method that can improve the stability of the welding process, reduce the weld spatter rate, and enhance the quality of weld joints through the adjustment of welding wire components.

### SUMMARY OF THE DISCLOSURE

The purpose of this disclosure is to provide a full slag covering, spatter-free flux-cored welding wire, directing to solving the technical problems of weld spatters and poor stability existing in the traditional welding process.

The present disclosure provides a full slag covering, spatter-free flux-cored welding wire, which includes a flux core and a metal sheath. The flux core is based on a neutral slag system of calcium oxide-titanium dioxide-alumina. During the welding process, molten drops are prevented from flying out to form spatters under the action of liquid slag. The formulation of the flux core is composed of rutile, fluoride, titanate, aluminum powder, manganese powder, chromium powder, molybdenum powder, and iron powder, and the mass percentages of respective components are: rutile 15%-35%, fluoride 15%-35%, calcium titanate 3%-7%, aluminum powder 5%-10%, manganese powder 10%-20%, chromium powder 3%-5%, molybdenum powder 3%-15%, a rest is iron powder or nickel powder.

In some embodiments, the fluoride is composed of a combination of CaF₂, LiF, NaF and BaF₂, and mass ratios are CaF₂: 60%-100%, LiF: 0-20%, NaF: 0-20% and BaF₂: 0-30%.

In some embodiments, a powder filling rate of the flux-cored welding wire is 20%-30%.

In some embodiments, the fluoride undergoes a hydrolysis reaction with water to produce calcium oxide, to remove hydrogen elements in a welding area; the calcium oxide then reacts with the rutile to form a composite oxide slag to maintain the liquid slag stably above a liquid molten pool.

In some embodiments, the role of the aluminum powder is for slagging and deoxidation, and the aluminum powder is also configured to undergo an endothermic reaction to delay melting time of the welding wire, increase dry elongation of the welding wire, and reduce distance from an end of the welding wire to a base material, making it easy for the slag to contact the molten drops to assist in transition and facilitating a coverage behavior of the slag on a welding arc.

In some embodiments, the role of the manganese powder is to deoxidize and desulfurize, and transition into the weld metal to achieve strengthening.

In some embodiments, a mesh number of the powder of the flux core is less than 200.

In some embodiments, the metal sheath is made of low-carbon steel or nickel strip.

This disclosure provides a welding wire that improves the stability of the welding process, reduces the weld spatter rate, and improves the quality of weld joints by adjusting the composition of the welding wire. The basic formulation of the fluoride-rutile creates a high-melting-point slag system of CaO—TiO₂—Al₂O₃, which may cover the liquid metal and isolate it from the influence of oxygen, nitrogen, hydrogen and other elements in the external environment during the welding process. This high-melting-point slag assists in the transition of the molten drops by means of preventing the spatters from flying away, guiding the transition of the molten drops, and covering the arc and molten drop transition area, thereby reducing spatters. The full coverage form of high-melting-point slag reduces the fluctuation of liquid metal, delays heat dissipation, and effectively optimizes the morphology of the weld seam.

### BRIEF DESCRIPTION OF DRAWINGS

FIG. 1 is a schematic view of the process in which the high-melting-point slag prevents the molten drops from flying out and forming spatters;

FIG. 2 is a schematic view of the process in which the high-melting-point slag assists in the transition of the molten drops;

FIG. 3 is a schematic view of the process in which the high-melting-point slag covers the arc and the molten drops completely.

### DESCRIPTION OF THE REFERENCE SIGNS

1. welding torch; 2. welding wire; 3. molten drops at the end of the welding wire; 4. arc; 5. workpiece; 6. molten drops; 7. liquid slag; 8. liquid metal; 9. solidified slag; 10. solidified weld seam.

### DESCRIPTION OF EMBODIMENTS

In order to make the technical problems, technical solutions and beneficial effects to be solved by the present disclosure clearer, the present disclosure will be described in further detail below with reference to the accompanying drawings and embodiments. It should be understood that the specific embodiments described herein are only used to explain the present disclosure, but not to limit the present disclosure.

This embodiment provides a full slag covering, spatter-free flux-cored welding wire, which consists of a flux core and a metal sheath. The metal sheath is selected from H08A (low-carbon steel), N6 nickel strip (stainless steel), or other materials with similar composition of a workpiece to be welded based on the composition of target workpiece to be welded. The flux core is a slag system based on a high-melting-point slag of calcium oxide-titanium dioxide-aluminum oxide, and molten drops are prevented from flying out to form spatters under the action of liquid slag in a welding process.

The flux core is composed of rutile, fluoride, titanate, aluminum powder, manganese powder, chromium powder, molybdenum powder and iron powder, and mass percentages of respective components are: 15%-35% rutile, 15%-35% fluoride, 3%-7% calcium titanate, 5%-10% aluminum powder, 10%-20% manganese powder, 3%-5% chromium powder, 3%-15% molybdenum powder, and a remainder is iron powder or nickel powder.

The fluoride is composed of a combination of CaF₂, LiF, NaF and BaF₂, and mass ratios are CaF₂: 60%-100%, LiF: 0-20%, NaF: 0-20% and BaF₂: 0-30%.

Mechanisms of action of respective components in the designed formulation of the flux-cored wire powder are as follows:

During the welding process, the fluoride undergoes a hydrolysis reaction of CaF₂+H₂O→CaO+2HF↑ with water to produce calcium oxide, while removing hydrogen elements in the welding area and reducing the amount of the diffusible hydrogen. The produced calcium oxide then undergoes a reaction of CaO+TiO₂→CaTiO₃ with titanium dioxide (rutile) at high temperature to form composite oxide slag in the form of mCaO·nTiO₂, mainly composed of a high-density and high-melting-point phase of CaTiO₃. The liquid slag can be maintained stably above the liquid molten pool during the welding process and will not evaporate in large amounts when close to and covering the arc, which is conducive to bringing the slag close to the arc area and realizing the adjustment of slag on the transition process of the molten drops. Therefore, the relative content ratio of the fluoride and the titanium dioxide is close to 1:1.

In addition to slagging, the titanium dioxide can also function to stabilize the arc during the welding process. However, an excess of TiO₂ is easy to cause slag inclusion in the weld seam, while too much fluoride may lower the melting point of the slag and increase its fluidity, making it difficult for the liquid slag to float and affecting the coverage of the slag on the surface of the molten pool. Furthermore, a reaction of 4CaO+3TiO₂→Ca₄Ti₃O₁₀ will take place to produce a Ca₄Ti₃O₁₀ composite oxide, which has a greater density and will sink after solidification, adhering to the surface of the weld metal and being difficult to remove, thereby causing defects such as inclusions easily. To avoid this, the fluoride content is determined to be 15%-35%, and the rutile content is 15%-35%.

Calcium titanate powder functions to form the slag, and the relative content of calcium titanate and fluoride-titanium dioxide is adjusted based on the specific environment in which the welding wire is used. A high ratio of fluoride-titanium dioxide to a low ratio of calcium titanate is used in underwater environment; while a low ratio of fluoride-titanium dioxide to a high ratio of calcium titanate is used in dry air. Thus, the calcium titanate content is determined to be 3%-7%.

The role of the aluminum powder is for slagging and deoxidation, and the aluminum powder is also configured to undergo an endothermic reaction of 4Al+3TiO₂≈2Al₂O₃+3Ti, which delays melting time of the welding wire, increases dry elongation of the welding wire, and reduces distance from an end of the welding wire and to a base metal, making it easy for the slag to contact the molten drops to assist in transition, and facilitating coverage behavior of the slag on a welding arc. However, using excessive aluminum powder may negatively affect the mechanical properties of welded joints. To avoid this, the aluminum powder content is configured to be 5%-10%.

The role of the manganese powder is to deoxidize and desulfurize and transition to a weld metal for strengthening. However, excessive manganese may increase the ionization voltage, which can disrupt the stability of the arc. To avoid this, the manganese powder content content is determined to be 10%-20%.

The powder used should maintain sufficient fluidity as well as have a certain degree of compressibility. Therefore, the selected powder mesh number needs to be less than 200.

The self-protecting flux-cored welding wire designed according to the present disclosure allows for combined slag-gas protection. The slag system of calcium oxide-titanium dioxide-alumina, which is formed by welding, has the characteristics of high viscosity, high density, and high melting point. This reduces the vaporization phenomenon under the influence of the arc temperature, making it possible to create a good covering effect on the molten pool surface, isolating the interference from the external air or underwater environment, and enhancing the welding stability. The high-melting-point slag formed during the welding process covers the surface of the molten pool, and the spatter rate is reduced by introducing the molten drops to facilitate their transition, covering the arc and the molten drops to reduce the repulsive force on the molten drops, and forming a high slag wall to prevent spatters from flying away from the welding area. The heat loss of welded joints covered by the slag is greatly reduced, the welding metallurgical process is prolonged, and the metallurgical effect is improved. The environmental chilling effect is weakened, and the weld seam is formed regularly. During the welding process, the molten pool is isolated from hydrogen, nitrogen and other elements by the high-melting-point slag, and the oxygen elements in the environmental medium will be reduced and consumed by the deoxidizer in the slag, thus resulting in better performance of the welded joints.

The principles of the flux-cored welding wire provided in this disclosure during the welding process are as follows:

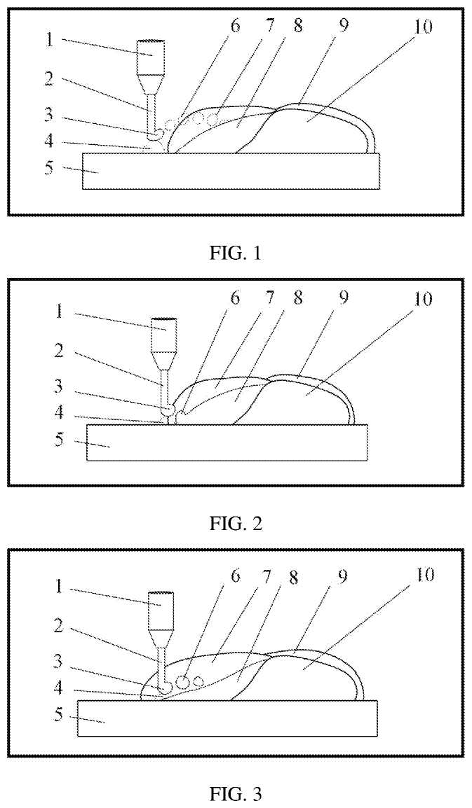

As shown in FIG. 1, a welding wire 2 is installed on a welding torch 1, to weld a workpiece 5. A main slagging component of a flux-cored of the welding wire 2 is used to obtain a high-melting-point neutral basic slag system of CaO—TiO₂—Al₂O₃. By adjusting the composition, liquid slag 7 is completely separated from liquid metal 8, forming distinct layers. In the meantime, the liquid slag 7 completely covers the liquid metal 8 and forms a covering layer with a certain height, which separates the liquid metal from the surrounding environment and avoids the interference of oxygen, nitrogen, hydrogen, etc. in the welding environment on the welding process. Molten drops at the end of the welding wire 3, which are stably formed and grow up at an end of the welding wire, may fly away from the welding area and form the repulsive splashing molten drops 6 under the action of accidental factors such as instantaneous short circuits, however, the liquid slag 7 with a certain height can intercept the splashing drops 6, which are caused to enter inside the liquid metal 8 under the action of gravity and density difference, avoiding becoming weld spatters. The liquid metal 8 then forms a solidified weld seam 10, and the liquid slag 7 forms a solidified slag 9. This is a first low-spatter implementation of the low-spatter, self-shielded flux-cored welding wire of the present disclosure.

As shown in FIG. 2, the liquid slag 7, formed during the welding process of the flux-cored of the welding wire 2, is layered with the liquid metal 8, which is completely covered by the liquid slag 7 to isolate the influence of oxygen, nitrogen, and hydrogen in the welding environment. Meanwhile, since the liquid slag 7 has a higher melting point and density, it can exist stably in an area close to welding arc 4. When the molten drops at the end of the welding wire 3 are formed to a certain size, the slag may come into contact with them to enhance the force effect of the molten drops. This allows the molten drops at the end of the welding wire 3 to enter into the slag in advance, thereby reducing the likelihood of repulsive transition occurring and preventing the formation of weld spatters. Subsequently, the liquid metal 8 forms the solidified weld seam 10, while the liquid slag 7 forms the solidified slag 9.

As shown in FIG. 3, the liquid slag 7 formed during the welding process of the flux-cored welding wire 2 completely covers the liquid metal 8 and forms layers. Due to the good conductivity of the liquid slag 7, the welding arc 4 can burn stably under the enclosure of the liquid slag 7, and the transition process of the molten drops is also carried out inside the liquid slag 7. The molten drops 6 separate from the end of the welding wire under the action of the slag when their volume is minimal, and then go into the liquid metal 8. During the whole process, the molten drops 6 always stay inside the liquid slag 7 and are completely isolated from the outside world, so the number of the weld spatters is greatly reduced. Then the liquid metal 8 forms the solidified weld seam 10, and the liquid slag 7 forms the solidified slag 9. In addition, the heat dissipation condition of the molten pool is improved, the heat dissipation process is slowed down, the welding metallurgical reaction is carried out more completely, and the amount of impurity elements in the welded joint is also controlled in a lower range, thus resulting in good joint performance.

The specific embodiments of the present disclosure use N6 nickel belt as the metal sheath, rutile 15%-35%, fluoride 15%-35%, calcium titanate 3%-7%, aluminum powder 5%-10%, manganese Powder 10%-20%, chromium powder 3%-5%, molybdenum powder 3%-15% and iron powder 0-4% as the flux core components. The powder is dried and screened to a particle size of 80-200 mesh. Five groups of powders with different composition contents, as shown in Tab.1, are accurately weighed and mixed in a powder mixer for 5 hours, and then taken out to prepare the welding wire.

TABLE 1
Proportions of respective components of the low-spatter flux-cored welding wire

| Embod- | Calcium | Lithium | Sodium | Barium | | Calcium | Aluminum | Manganese | Molybdenum | Chrome | Iron | Nickel |
|---|---|---|---|---|---|---|---|---|---|---|---|---|
| iment | fluoride | fluoride | fluoride | fluoride | Rutile | titanate | powder | powder | powder | powder | powder | powder |
| 1 | 30 | 2 | 1 | 2 | 35 | 3 | 5 | 10 | 5 | 3 | 4 | 0 |
| 2 | 13 | 1 | 1 | 0 | 15 | 7 | 10 | 20 | 15 | 3 | 15 | 0 |
| 3 | 25 | 2 | 0 | 3 | 21 | 7 | 7 | 15 | 9 | 3 | 8 | 0 |
| 4 | 25 | 0 | 2 | 0 | 27 | 3 | 7 | 10 | 11 | 5 | 0 | 10 |
| 5 | 32 | 1 | 0 | 2 | 32 | 3 | 5 | 15 | 3 | 5 | 0 | 2 |

In the method of fabricating the low-spatter flux-cored welding wire with high melting point slag-assisted transition of the present disclosure, N6 nickel strip is used in embodiments 1 to 3, and H08A steel strip is used in embodiments 4 to 5 with the specification of 0.3 mm×0.8 mm. An O-shaped welding wire with a diameter of 1.6 mm and a seam on the cross-section is prepared on a standard flux-cored wire production line, with a flux core filling rate of 20%-30%.

The welding base material used in the embodiments of the present disclosure is a 304 stainless steel plate with a thickness of 10 mm. The welding in embodiments 1, 2 and 4 is conducted in the normal air environment, while the welding in embodiments 3 and 5 is conducted underwater at a depth of 0.5 m. The length of the weld seam is 30 cm. The mechanical properties and spatter rate of the molten metal of five groups of flux-cored wires with different composition contents after welding obtained from the experiment are shown in Tab. 2.

TABLE 2
Mechanical properties and spatter rate of the
molten metal of wires after welding

| Embodiment | 1 | 2 | 3 | 4 | 5 |
|---|---|---|---|---|---|
| Tensile strength (MPa) | 596 | 587 | 553 | 577 | 569 |
| Number of spatters | 7 | 3 | 2 | 2 | 7 |
| (No.) | | | | | |

It can be seen that the full slag covering, spatter-free flux-cored welding wire according to the embodiments of the present disclosure, which is based on the high-melting-point slag system, exhibits excellent performance in the welding process. The generation of weld spatter is effectively reduced on the basis of ensuring tensile strength of the welded joints, thus solving the problems of high spatter rate and poor stability in the flux-cored wire welding, particularly in underwater welding.

The described embodiments are merely intended to describe the technical solutions of the present disclosure, and should not be regarded as limitation. Although the present disclosure is illustrated in detail with reference to the foregoing embodiments, persons of ordinary skill in the art should understand that they may still make modifications to the technical solutions described in the foregoing embodiments or equivalent substitutions to some or all of the technical features thereof, and these modifications or substitutions will not make the essence of the corresponding technical solutions deviate from the scope of the technical solutions of embodiments of the present disclosure.

1. A full slag covering, spatter-free flux-cored welding wire, comprising a flux core and a metal sheath, wherein the flux core is a slag system based on a neutral slag of calcium oxide-titanium dioxide-aluminum oxide, molten drops are prevented from flying out to form spatters under action of liquid slag in a welding process, the flux core is composed of rutile, fluoride, titanate, aluminum powder, manganese powder, chromium powder, molybdenum powder and iron powder, and mass percentages of respective components are: 15%-35% rutile, 15%-35% fluoride, 3%-7% calcium titanate, 5%-10% aluminum powder, 10%-20% manganese powder, 3%-5% chromium powder, 3%-15% molybdenum powder, and a remainder is iron powder or nickel powder.

2. A full slag covering, spatter-free flux-cored welding wire according to claim 1, wherein the fluoride is composed of a combination of CaF₂, LiF, NaF and BaF₂, and mass ratios are CaF₂: 60%-100%, LiF: 0-20%, NaF: 0-20% and BaF₂: 0-30%.

3. A full slag covering, spatter-free flux-cored welding wire according to claim 1, wherein a powder filling rate of the flux-cored welding wire is 20%-30%.

4. A full slag covering, spatter-free flux-cored welding wire according to claim 1, wherein the fluoride undergoes a hydrolysis reaction with water to produce calcium oxide, to remove hydrogen elements in a welding area; and the calcium oxide reacts with the rutile to form a composite oxide slag to maintain the liquid slag stably above a liquid molten pool.

5. A full slag covering, spatter-free flux-cored welding wire according to claim 1, wherein the role of the aluminum powder is for slagging and deoxidation; and the aluminum powder is also configured to undergo an endothermic reaction to delay melting time of the welding wire, increase dry elongation of the welding wire, and reduce distance from an end of the welding wire and to a base metal, making it easy for the slag to contact the molten drops to assist in transition, and facilitating coverage behavior of the slag on a welding arc.

6. A full slag covering, spatter-free flux-cored welding wire according to claim 1, wherein the role of the manganese powder is to deoxidize and desulfurize, and transition into weld metal to achiever strengthening.

7. A full slag covering, spatter-free flux-cored welding wire according to claim 1, wherein a mesh number of the powder of the flux core is less than 200.

8. A full slag covering, spatter-free flux-cored welding wire according to claim 1, wherein the metal sheath is made of low-carbon steel or nickel strip.
